(19) United States
(12) Patent Application Publication
(10) Pub. No.: US 2016/0071030 A1
(43) Pub. Date: Mar. 10, 2016

(54) PARKING SPACE RESERVATION

(71) Applicant: ProSports Technologies, LLC, Miami, FL (US)

(72) Inventors: John E. Cronin, Bonita Springs, FL (US); Seth Melvin Cronin, Milton, VT (US)

(21) Appl. No.: 14/839,151

(22) Filed: Aug. 28, 2015

Related U.S. Application Data
(60) Provisional application No. 62/047,182, filed on Sep. 8, 2014.

(51) Int. Cl. G06Q 10/02

(52) U.S. Cl. CPC G06Q 10/02

(57) ABSTRACT

The present invention includes systems and methods for providing parking space reservation. One or more cameras may provide parking lot information for one or more parking lots. Parking lot information may be processed for delivery to one or more user devices. Each of the one or more user devices may be provided with an application for download. Parking lot information may be delivered to the application based on parameters provided by an application user. The application user may reserve one or more parking spaces using the application.

### CROSS-REFERENCE TO RELATED APPLICATIONS

This application claims the priority benefit of U.S. provisional application No. 62/047,182, filed on Sep. 8, 2014 and titled “Camera Monitor Network In Parking Lot to Inform Preferred Customers,” the disclosure of which is incorporated herein by reference.

### BACKGROUND OF THE INVENTION

1. Field of the Invention

The present invention relates generally to providing parking space reservation. More specifically, the present invention relates to using real-time parking information at a user device.

2. Description of the Related Art

Venues currently have a variety of options for providing parking accommodations at events. Venues may use signage and parking attendants to direct attendees to parking lots. Signage and parking attendants may provide information regarding parking lot vacancy. Parking attendants may direct traffic to a second parking lot when a first parking lot is full.

It is difficult, however, to provide real-time details regarding parking vacancies. It is difficult for an attendee, for example, to view real-time parking lot vacancy information for multiple parking lots on a user device and reserve one or more parking spaces based on the real-time information. It is also difficult to view real-time parking lot information regarding vacant handicapped parking spaces.

There is a need in the art for improved systems and methods for providing parking space reservation.

### SUMMARY OF THE PRESENTLY CLAIMED INVENTION

One exemplary method for providing parking space reservation describes receiving parking lot information from one or more cameras. Parking lot information is associated with an event. The method also describes processing parking lot information to generate vacancy information. The method also describes providing vacancy information to a user device. The user device is associated with one or more event tickets purchased for the event. The method also describes reserving one or more vacant parking spaces. Reservation of the one or more vacant parking spaces is based upon one or more requests from the user device.

One exemplary system for providing parking space reservation provides one or more cameras and a processor. Execution of instructions stored in the memory by the processor performs a set of operations. The operations include receiving parking lot information from the one or more cameras. Parking lot information is associated with an event. The operations also include processing parking lot information to generate vacancy information. The operations also include providing vacancy information to a user device. The user device is associated with one or more event tickets purchased for the event. The operations also include reserving one or more vacant parking spaces. Reservation of the one or more vacant parking spaces is based upon one or more requests from the user device.

One exemplary non-transitory computer-readable storage medium is also described, the non-transitory computer-readable storage medium having embodied thereon a program executable by a processor for providing parking space reservation. The exemplary program method describes receiving parking lot information from one or more cameras. Parking lot information is associated with an event. The program method also describes processing parking lot information to generate vacancy information. The program method also describes providing vacancy information to a user. The user is associated with one or more event tickets purchased for the event. The program method also describes reserving one or more vacant parking spaces. Reservation of the one or more vacant parking spaces is based upon one or more requests from the user.

### BRIEF DESCRIPTION OF THE DRAWINGS

FIG. 1 illustrates an environment in which a system for providing parking space reservation may be implemented.

FIG. 2A illustrates a graphical user interface (GUI) for purchasing one or more tickets and one or more associated parking spaces.

FIG. 2B illustrates a GUI for downloading a parking application (“app”).

FIG. 2C illustrates a parking app GUI.

FIG. 2D illustrates a find-a-space GUI of a parking app.

FIG. 2E illustrates a reservation GUI.

FIG. 3A illustrates a workflow for processing parking lot data.

FIG. 3B illustrates a parking app graphical user interface (GUI) populated with processed information received from a camera monitors network.

FIG. 4 illustrates a workflow for processing attendee data for storage in a database.

FIG. 5 illustrates a database table included in a database.

FIG. 6 illustrates a method for providing parking space reservation.

### DETAILED DESCRIPTION

The present invention includes systems and methods for providing parking space reservation. One or more cameras may provide parking lot information for one or more parking lots. Parking lot information may be processed for delivery to one or more user devices. Each of the one or more user devices may be provided with an application for download. Parking lot information may be delivered to the application based on parameters provided by an application user. The application user may reserve one or more parking spaces using the application.

Parking space reservation may be provided at entertainment or cultural events that are presented at a theatre, gymnasium, stadium, or other facility to a group of people. Such events include a wide variety of sporting events such as football (American and Global), baseball, basketball, soccer, ice hockey, lacrosse, rugby, cricket, tennis, track and field, golf, cycling, motor sports such as automobile or motorcycle racing, horse racing, Olympic games, and the like; cultural events such as concerts, music festivals, plays, the opera, and the like; religious events; and more permanent exhibitions such as museum, historic home, and the like.

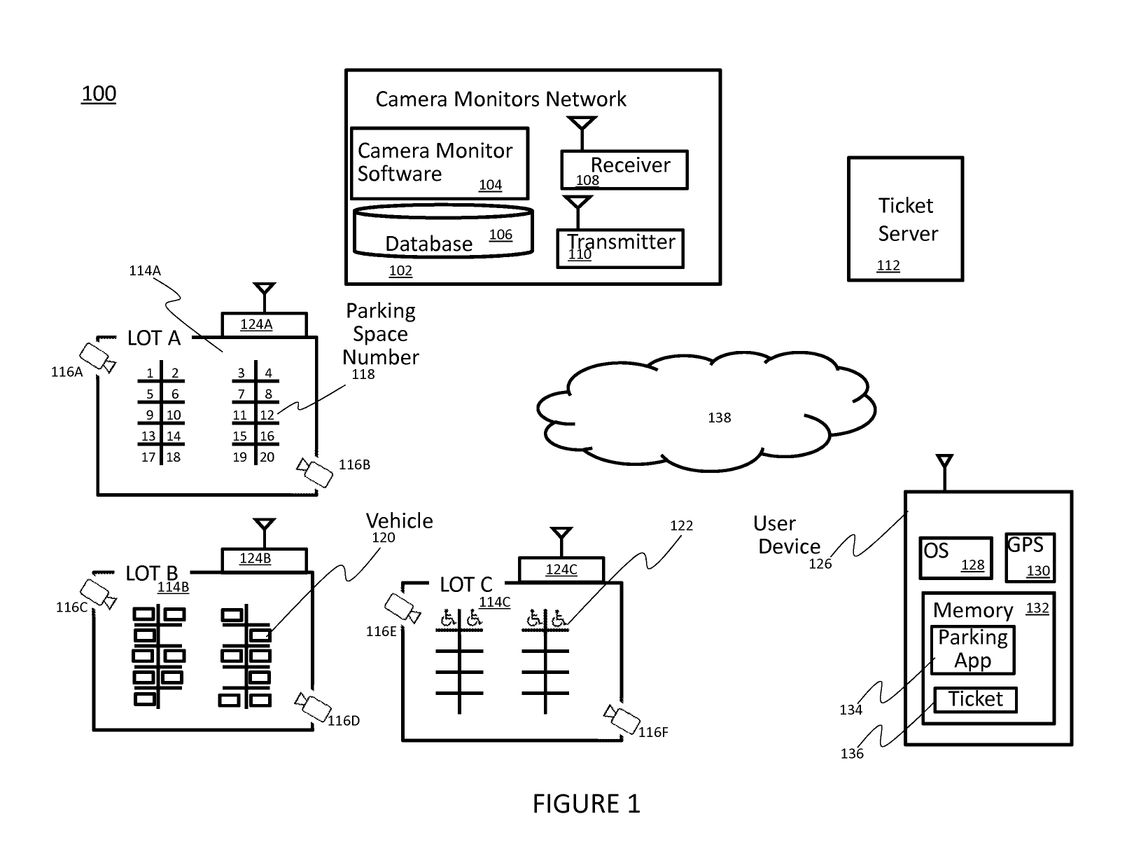

FIG. 1 illustrates an environment 100 in which a system for providing parking space reservation may be implemented. The environment 100 of FIG. 1 may include a camera monitors network 102, a ticket server 112, one or more parking lots 114A-C, a communication network 138 (e.g., the cloud or Internet), and a user device 126. The camera monitors network 102 may include a camera monitor software 104, a database 106, a receiver 108, and a transmitter 110. The camera monitors network may also include a processor and memory. The processor may execute instructions or access information that may be stored in memory. The camera monitor software 104 may be stored in memory.

Each of the one or more parking lots 114A-C may include one or more cameras 116A-F, a communication interface 124A-C, and one or more parking space numbers 118. Each of the one or more parking lots 114A-C may also include one or more vehicles 120. Each of the one or more parking lots 114A-C may also include one or more handicapped parking spaces 122. The user device 126 may include a Global Positioning System (GPS) unit 130 and memory 132. The user device 126 may also include a processor. The user device 126 may also include an operating system 128. Memory 132 may store instructions and data for execution by the processor. Memory 132 may include a parking application (“app”) 134 and an electronic ticket 136.

Each of the one or more cameras 116A-F may collect information for an associated parking lot 114A-C. Each of the one or more parking lots 114A-C may transmit information collected by the one or more associated cameras 116A-F through the communication network 138 using the associated communication interface 124A-C.

Each of one or more parking spaces in a parking lot 114A-C may be viewed from at least one of the one or more associated cameras 116A-F. Each of the one or more cameras 116A-F may provide the one or more parking space numbers 118, information regarding the one or more vehicles 120, and information regarding the one or more handicapped parking spaces 122.

The camera monitors network 102 may receive information from the one or more parking lots 114A-C via the receiver 108. The camera monitors network 102 may process the received information using the camera monitor software 104. The camera monitors network 102 may transmit processed information to the user device 126 via the transmitter 110. The transmitter 110 may transmit the processed information to the user device 126 via the communication network 138. The camera monitors network 102 may also transmit processed information to the database 106.

The ticket server 112 may process attendee data for storage in the database 106. The ticket server 112 may provide one or more graphical user interfaces (GUIs) to a user, through which one or more event tickets may be purchased by the user. The user may also purchase one or more event parking spaces through the one or more GUIs. The ticket server 112 may process for storage in the database 106 information associated with the one or more event ticket purchases. The ticket server 112 may also process for storage in the database 106 information associated with the one or more event parking space purchases.

The user device 126 may use the GPS unit 130 to provide location information to the parking app 134. The parking app 134 may use the electronic ticket 136 to provide parking information for the associated event. The parking app 134 may allow the user to reserve one or more parking spaces after the user purchases the one or more parking spaces.

The user device 126 may be any type of computing device capable of communicating over the communication network 138. Such a computing device may include general purpose computers, mobile phones, smartphones, personal digital assistants (PDAs), portable computing devices (e.g., laptop, netbook, tablets), desktop computing devices, and handheld computing devices.

The communication network 138 may be a local, proprietary network (e.g., an intranet) and/or may be a part of a larger wide-area network. The communication network 138 may be a local area network (LAN), which may be communicatively coupled to a wide area network (WAN) such as the Internet. The Internet is a broad network of interconnected computers and servers allowing for the transmission and exchange of Internet Protocol (IP) data between users connected through a network service provider. Examples of network service providers are the public switched telephone network, a cable service provider, a provider of digital subscriber line (DSL) services, or a satellite service provider.

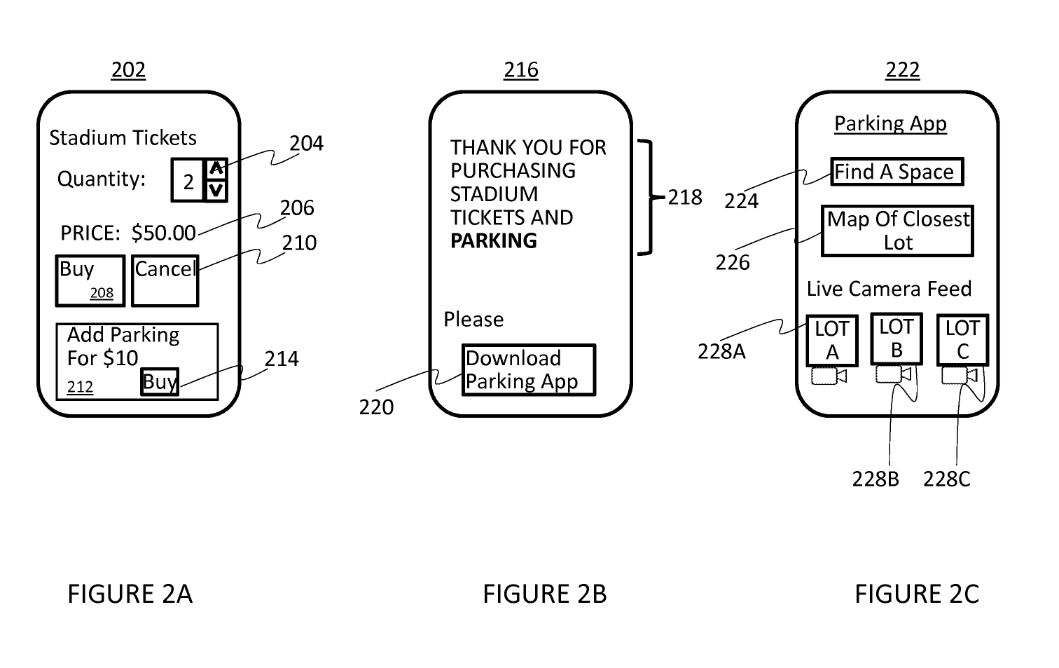

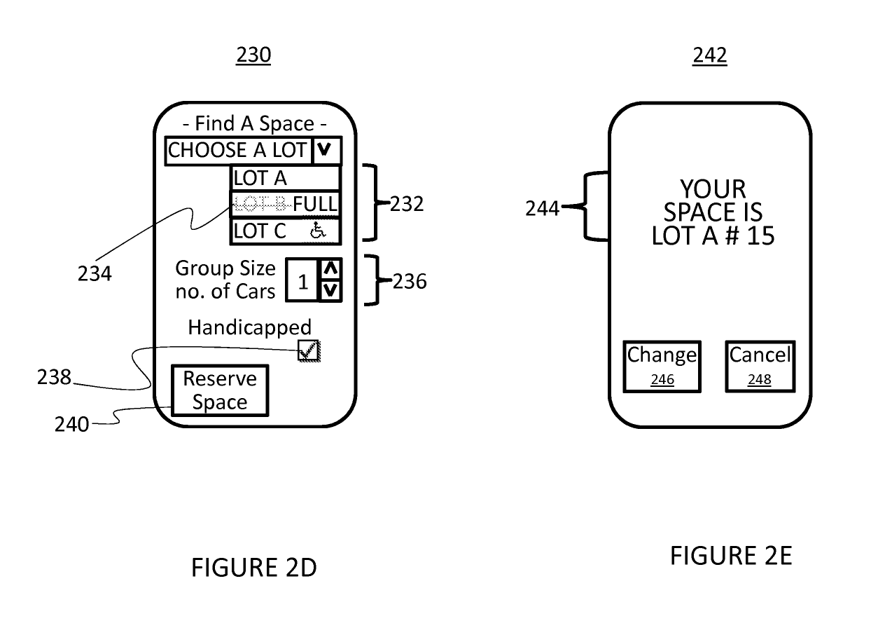

FIG. 2A illustrates a graphical user interface (GUI) 202 for purchasing one or more tickets and one or more associated parking spaces. The GUI 202 may include a ticket quantity selector 204, a ticket price display 206, a buy button 208, and a cancel button 210. The GUI 202 may also include a parking pop-up display 212. The parking pop-up display 212 may include a second buy button 214. The GUI 202 may be provided by the ticket server 112. The GUI 202 may be viewed using the user device 126.

A user device user may purchase one or more tickets using the GUI 202. The user may also purchase one or more parking spaces associated with the one or more tickets using the GUI 202. The user may indicate a quantity of tickets the user desires to purchase using the ticket quantity selector 204. The user may, for example, select “2” using the quantity selector 204 when the user desires to purchase two tickets. The ticket price display 206 may display a total cost for the quantity of tickets selected by the user. The GUI 202 may, for example, display “$50.00” when the user selects “2” using the quantity selector 204 and the total cost for two tickets is $50.00. The user may select the cancel button 210 when the user does not desire to proceed with making a purchase of the selected quantity of tickets. The user may select the buy button 208 when the user desire to proceed with making a purchase of the selected quantity of tickets.

The parking pop-up display 212 may appear when the user selects the buy button 208. The user may purchase one or more parking spaces associated with the one or more tickets by selecting the second buy button 214.

FIG. 2B illustrates a GUI 216 for downloading the parking app 134. The GUI 216 may include a confirmation message 218 and a download parking app button 220. The GUI 216 may appear when the user purchases one or more tickets and one or more associated parking spaces. The user may download the parking app 134 to a user device by selecting the download parking app button 220. The GUI 216 may be provided by the ticket server 112. The GUI 216 may be viewed using the user device 126.

FIG. 2C illustrates a parking app GUI 222. The parking app GUI 222 may include a find-a-space button 224, a map-of-closest-lot button 226, and one or more live camera feed buttons 228A-C. The GUI 222 may be viewed using the user device 126. The user may view a map of a parking lot 114A-C that is closest to the user's current location by selecting the map-of-closest-lot button 226. The user may view real-time video of a parking lot 114A-C by selecting a corresponding live camera feed button 228A-C.

FIG. 2D illustrates a find-a-space GUI 230 of the parking app 134. The find-a-space GUI 230 may appear when a user selects the find-a-space button 224 from the parking app GUI 222. The GUI 230 may include a parking lot drop-down menu 232, a parking space quantity selector 236, a handicapped parking selector 238, and a reserve space button 240. The GUI 230 may be viewed using the user device 126.

The user may reserve one or more parking spaces using the GUI 230. The user may limit the one or more parking space reservations to a parking lot 114A-C by selecting the parking lot 114A-C from the parking lot drop-down menu 232. The parking lot drop-down menu 232 may indicate that there are no available parking spaces in a parking lot. The parking lot drop-down menu 232 may, for example, indicate that there are no available parking spaces in a parking lot by displaying “FULL” 234 next to a corresponding parking lot identification.

The user may limit the one or more parking space reservations to handicapped spaces using the handicapped parking selector 238. The user may reserve the one or more parking spaces using the reserve space button 240, wherein the one or more parking space reservations may meet the requirements set by the user using the GUI 230.

FIG. 2E illustrates a reservation GUI 242. The reservation GUI 242 may appear when a user selects the reserve space button 240 from the GUI 230. The reservation GUI 242 may include a parking space message 244, a change button 246, and a cancel button 248. The GUI 242 may be viewed using the user device 126. The parking space message 244 may provide reservation information to the user. Reservation information may indicate the parking lot in which the one or more reserved parking spaces are located, as well as a reserved space number for each of the one or more reserved parking spaces. The parking space message 244, for example, may be “YOUR SPACE IS LOT A #15” when the user's reserved parking space is parking space “#15” in parking lot “A.”

The user may return to the find-a-space GUI 230 to change the parking reservation by selecting the change button 246. The user may cancel the parking reservation by selecting the cancel button 248.

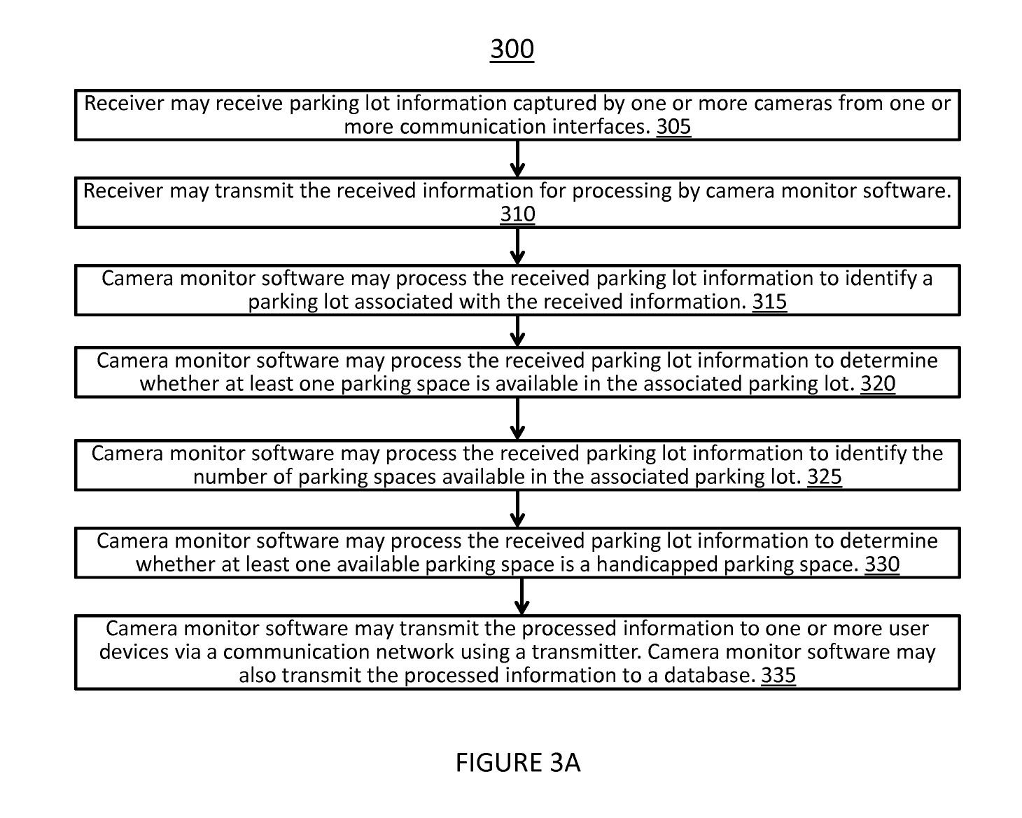

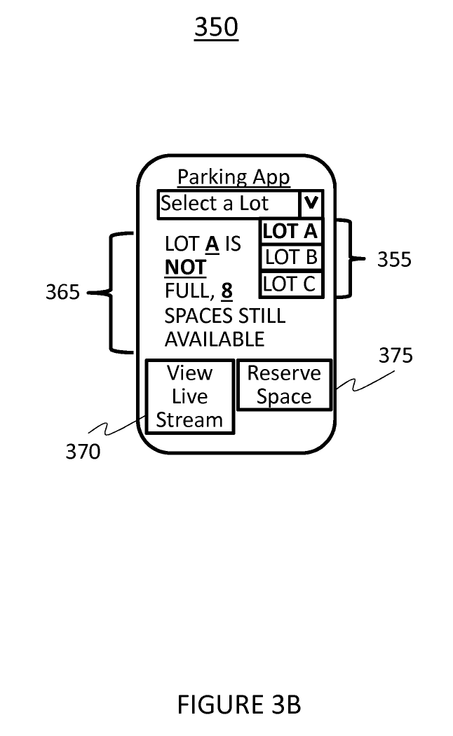

FIG. 3A illustrates a workflow 300 for processing parking lot data. In step 305 of FIG. 3A, the receiver 108 may receive parking lot information captured by the one or more cameras 116A-F from the one or more communication interfaces 124A-C. In step 310, the receiver 108 may transmit the received information for processing by the camera monitor software 104.

In step 315, the camera monitor software 104 may process the received parking lot information to identify a parking lot 114A-C associated with the received information. The camera monitor software 104 may, for example, identify a parking lot “A” 114A as a parking lot associated with the receive parking lot information.

In step 320, the camera monitor software 104 may process the received parking lot information to determine whether at least one parking space is available in the associated parking lot 114A-C.

In step 325, the camera monitor software 104 may process the received parking lot information to identify the number of parking spaces available in the associated parking lot 114A-C. The camera monitor software 104 may, for example, identify eight available parking spaces in the associated parking lot 114A-C.

In step 330, the camera monitor software 104 may process the received parking lot information to determine whether at least one available parking space is a handicapped parking space.

In step 335, the camera monitor software 104 may transmit the processed information to the user devices 126 via the communication network 138 using the transmitter 110. The camera monitor software 104 may also transmit the processed information to the database 106. The processed information may be stored in the database 106 and later retrieved for delivery to a user device 126.

FIG. 3B illustrates a parking app graphical user interface (GUI) 350 populated with processed information received from the camera monitors network 102. The GUI 350 may include a parking lot drop-down menu 355, an information message 365, a view live stream button 370, and a reserve space button 375.

The user may reserve one or more parking spaces using the GUI 350. The user may limit the one or more parking space reservations to a parking lot 114A-C by selecting the parking lot 114A-C from the parking lot drop-down menu 355.

The information message 365 may provide to the user information regarding a parking lot. The information message 365, for example, may be “LOT A IS NOT FULL, 8 SPACES STILL AVAILABLE” when the user selects a parking lot “A” from the parking lot drop-down menu 355 and there are eight spaces available in parking lot “A.” The user may view real-time video of a selected parking lot 114 by selecting the view live stream button 370. The user may reserve one or more parking spaces in a selected parking lot by selecting the reserve space button 375.

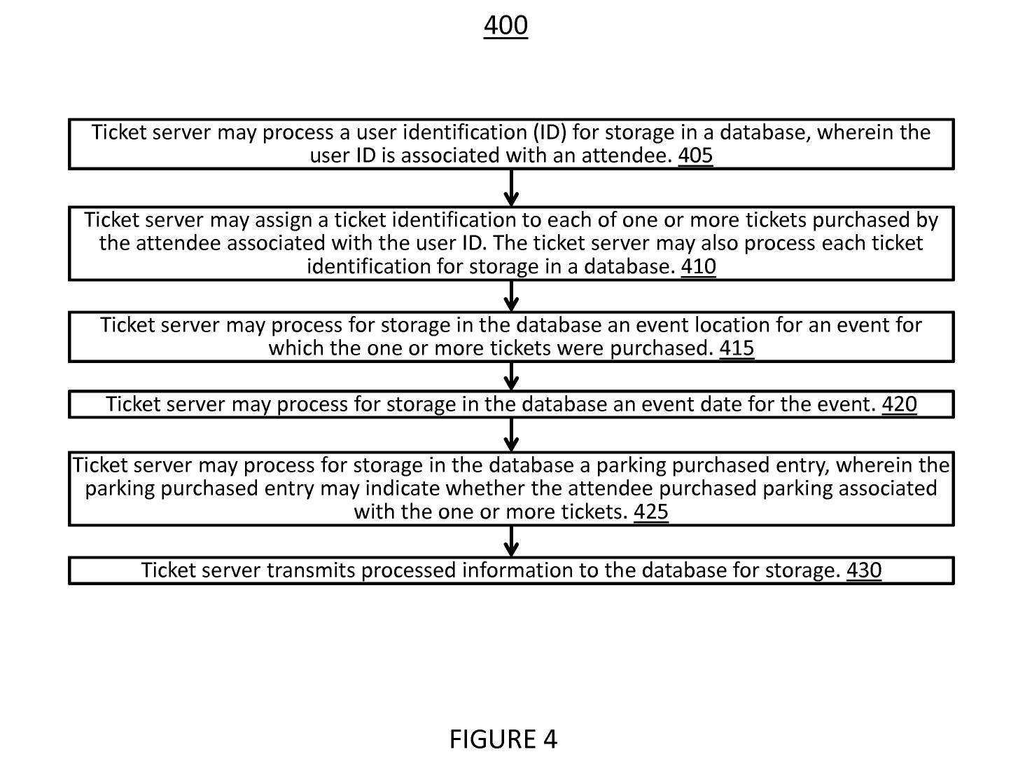

FIG. 4 illustrates a workflow 400 for processing attendee data for storage in the database 106. In step 405 of FIG. 4, the ticket server 112 may process a user identification (ID) for storage in the database 106, wherein the user ID is associated with an attendee. In step 410, the ticket server 112 may assign a ticket identification to each of one or more tickets purchased by the attendee associated with the user ID. The ticket server may also process each ticket identification for storage in the database 106. In step 415, the ticket server 112 may process for storage in the database 106 an event location for an event for which the one or more tickets were purchased. In step 420, the ticket server 112 may process for storage in the database 106 an event date for the event. In step 425, the ticket server 112 may process for storage in the database 106 a parking purchased entry, wherein the parking purchased entry may indicate whether the attendee purchased parking associated with the one or more tickets. In step 430, the ticket server transmits processed information to the database 106 for storage.

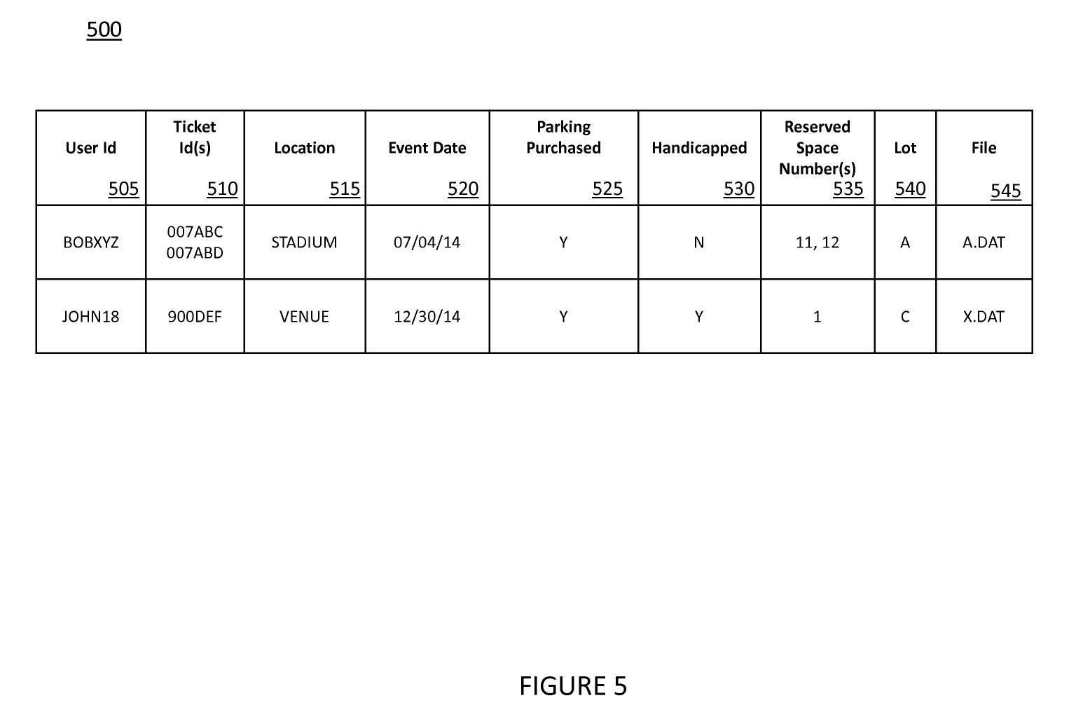

FIG. 5 illustrates a database table 500 included in the database 106. The database table 500 of FIG. 5 may include a user identification (ID) column 505, a ticket ID column 510, a location column 515, an event date column 520, a parking purchased column 525, a handicapped column 530, a reserved space number column 535, a lot column 540, and a file column 545. One or more user identifications may be entered into the user ID column 505. Each of the one or more user identification entries may be associated with one or more ticket identifications, an event location, an event date, a parking purchased entry, a handicapped parking entry, one or more reserved space numbers, a parking lot identification, and a data file.

Each of the one or more associated ticket identifications may be included in a corresponding entry in the ticket ID column 510. The database table 500 may include “BOBXYZ” in an entry in the user ID column 505 and “007ABC, 007ABD” in a corresponding entry in the ticket identification column 510, for example, when a user identified by a user ID of “BOBXYZ” has purchased a ticket identified by a ticket ID of “007ABC” and another ticket identified by a ticket ID of “007ABD.”

The associated event location may be included in a corresponding entry in the location column 515. The database table 500 may include “STADIUM” in a corresponding entry in the location column 515, for example, when a corresponding user has purchased one or more tickets for an event located at “STADIUM.”

The associated event date may be included in a corresponding entry in the event date column 520. The database table 500 may include “07/04/14” in a corresponding entry in the event date column 520, for example, when a corresponding user has purchased one or more tickets for an event occurring on a date of “07/04/14.”

The associated parking purchased entry may be included in a corresponding entry in the parking purchased column 525. The database table 500 may include “JOHN18” in an entry in the user ID column 505, “Y” in a corresponding entry in the parking purchased column 525, and “900DEF” in a corresponding entry in the ticket identification column 510, for example, when a user identified by a user ID of “JOHN18” has purchased parking and a ticket identified by a ticket ID of “900DEF” for an event.

The associated handicapped parking entry may be included in a corresponding entry in the handicapped column 530. The database table 500 may include “JOHN18” in an entry in the user ID column 505, “Y” in a corresponding entry in the parking purchased column 525, “Y” in a corresponding entry in the handicapped column 530, and “900DEF” in a corresponding entry in the ticket identification column 510, for example, when a user identified by a user ID of “JOHN18” has purchased parking and a ticket identified by a ticket ID of “900DEF” for an event, wherein the purchased parking is handicapped parking.

Each of the one or more associated reserved space numbers may be included in a corresponding entry in the reserved space number column 535. The database table 500 may include “11, 12” in a corresponding entry in the reserved space number column 535, for example, when a corresponding user has purchased a parking space identified as space “11” and another parking space identified as space “12.”

The associated parking lot identification may be included in a corresponding entry in the lot column 540. The database table 500 may include “C” in a corresponding entry in the lot column 540, for example, when a corresponding user has purchased one or more parking spaces in a parking lot identified as lot “C.”

The associated data file may be included in a corresponding entry in the file column 545. The database table 500 may include “JOHN18” in an entry in the user ID column 505 and “X.DAT” in a corresponding entry in the file column 540, for example, when information related to a user identified by a user ID of “JOHN18” is stored in a file identified as “X.DAT.”

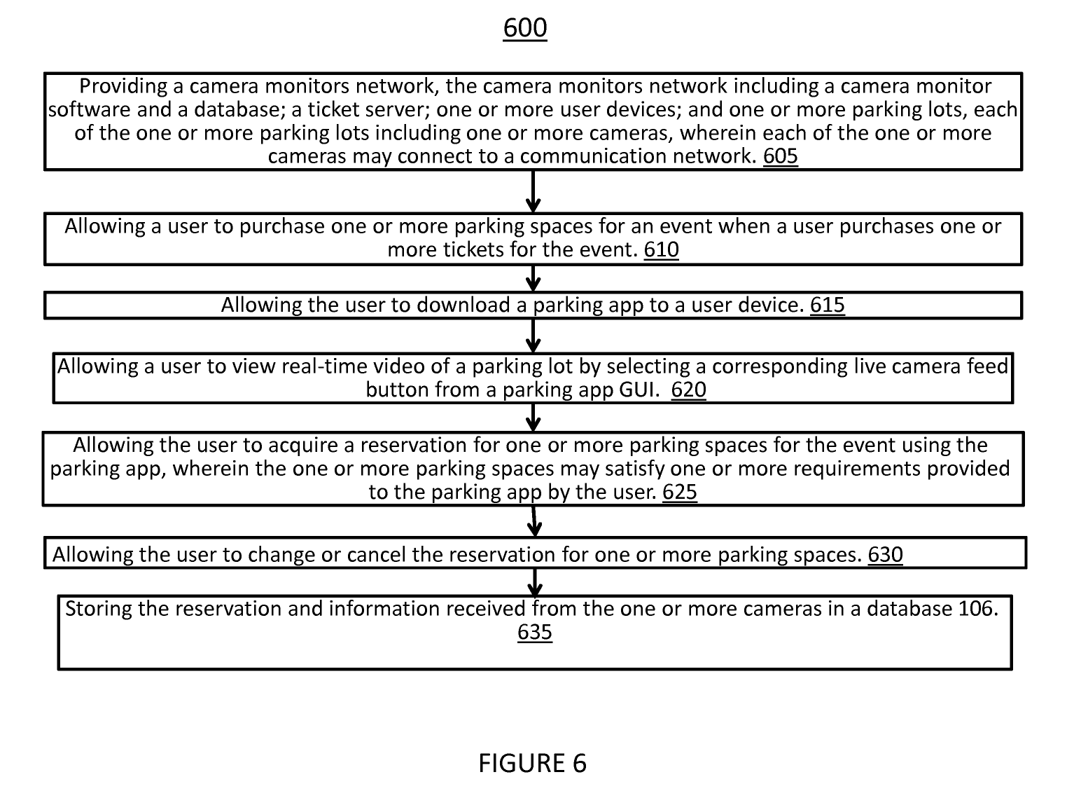

FIG. 6 illustrates a method 600 for providing parking space reservation. The method 600 of FIG. 6 may include, at block 605, providing a camera monitors network 102, the camera monitors network 102 including a camera monitor software 104 and a database 106; a ticket server 112; one or more user devices 126; and one or more parking lots 114, each of the one or more parking lots 114 including one or more cameras 116, wherein each of the one or more cameras 116 may connect to a communication network 138. The camera monitor software 104 may process information received from the one or more cameras 116 to identify a parking lot 114 associated with the received information; determine whether at least one parking space is available in the parking lot 114; identify the number of parking spaces available in the parking lot 114; and determine whether at least one available parking space is a handicapped parking space.

The method 600 may include, at block 610, allowing a user to purchase one or more parking spaces for an event when a user purchases one or more tickets for the event. The method 600 may include, at block 615, allowing the user to download a parking app 134 to a user device 126. The method may include, at block 620, allowing a user to view real-time video of a parking lot 114 by selecting a corresponding live camera feed button 228 from a parking app GUI.

The method 600 may include, at block 625, allowing the user to acquire a reservation for one or more parking spaces for the event using the parking app 134, wherein the one or more parking spaces may satisfy one or more requirements provided to the parking app 134 by the user. The method 600 may include, at block 630, allowing the user to change or cancel the reservation for one or more parking spaces.

The method 600 may include, at block 635, storing the reservation and information received from the one or more cameras 116 in a database 106.

The foregoing detailed description of the technology has been presented for purposes of illustration and description. It is not intended to be exhaustive or to limit the technology to the precise form disclosed. Many modifications and variations are possible in light of the above teaching. The described embodiments were chosen in order to best explain the principles of the technology, its practical application, and to enable others skilled in the art to utilize the technology in various embodiments and with various modifications as are suited to the particular use contemplated. It is intended that the scope of the technology be defined by the claim.

What is claimed is:

1. A method for providing parking space reservation, the method comprising:
receiving parking lot information from one or more cameras, wherein parking lot information is associated with an event,
processing parking lot information to generate vacancy information,
providing vacancy information to a user device, wherein the user device is associated with one or more event tickets purchased for the event, and
reserving one or more vacant parking spaces, wherein reservation of the one or more vacant parking spaces is based upon one or more requests from the user device.

2. The method of claim 1, wherein vacancy information is provided to an application at the user device.

3. The method of claim 2, wherein the application is provided for download to the user device when a user device user purchases one or more parking tickets for the event.

4. The method of claim 3, wherein the one or more parking tickets are provided for purchase when the user device user purchases the one or more event tickets.

5. The method of claim 1, wherein each of one or more parking lots include one or more parking spaces.

6. The method of claim 5, wherein parking lot information includes information for each of the one or more parking spaces.

7. The method of claim 1, wherein vacancy information includes identification of a closest parking lot relative to a current location of the user device.

8. A system for providing parking space reservation, the system comprising:
one or more cameras, and
a processor that executes instructions stored in memory, the instructions executed to:
receive parking lot information from the one or more cameras, wherein parking lot information is associated with an event,
process parking lot information to generate vacancy information,
provide vacancy information to a user device, wherein the user device is associated with one or more event tickets purchased for the event, and
reserve one or more vacant parking spaces, wherein reservation of the one or more vacant parking spaces is based upon one or more requests from the user device.

9. The system of claim 8, wherein vacancy information is provided to an application at the user device.

10. The system of claim 9, wherein the application is provided for download to the user device when a user device user purchases one or more parking tickets for the event.

11. The system of claim 10, wherein the one or more parking tickets are provided for purchase when the user device user purchases the one or more event tickets.

12. The system of claim 8, wherein each of one or more parking lots include one or more parking spaces.

13. The system of claim 12, wherein parking lot information includes information for each of the one or more parking spaces.

14. The system of claim 8, wherein vacancy information includes identification of a closest parking lot relative to a current location of the user device.

15. A non-transitory computer-readable storage medium having embodied thereon a program executable by a processor for providing parking space reservation, the method comprising:
receiving parking lot information from one or more cameras, wherein parking lot information is associated with an event,
processing parking lot information to generate vacancy information,
providing vacancy information to a user, wherein the user is associated with one or more event tickets purchased for the event, and
reserving one or more vacant parking spaces, wherein reservation of the one or more vacant parking spaces is based upon one or more requests from the user.

16. The non-transitory computer-readable storage medium of claim 15, wherein vacancy information is provided to the user through an application.

17. The non-transitory computer-readable storage medium of claim 15, wherein each of one or more parking lots include one or more parking spaces.

18. The non-transitory computer-readable storage medium of claim 17, wherein parking lot information includes information for each of the one or more parking spaces.

19. The non-transitory computer-readable storage medium of claim 18, wherein vacancy information includes identification of a closest parking lot relative to a current location of the user.
